(19) United States
(12) Patent Application Publication
(10) Pub. No.: US 2003/0233474 A1
(43) Pub. Date: Dec. 18, 2003

(54) Path calculating apparatus with switchable path selection criteria

(75) Inventor: Masaki Yamamoto, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/458,294

(22) Filed: Jun. 11, 2003

(30) Foreign Application Priority Data
Jun. 12, 2002 (JP) 2002-171848

(51) Int. Cl. G06F 15/173

(52) U.S. Cl. 709/239; 714/4

(57) ABSTRACT

When a protection type is 1+1, it is possible to carry out a path calculation so as to guarantee optimization of a sum of metrics of an active path and a backup path. This is because two exclusive paths having a minimum sum of metrics of the two exclusive paths are calculated. When the protection type is 1:1 or 1:N, it is possible to carry out a path calculation so as to guarantee optimization of the active path. This is because, from among candidate pairs of candidate paths for the active path and of candidate paths for the backup path, one pair including the candidate path for the active path having a minimum metric is calculated.

This application claims priority to prior application JP 2002-171848, the disclosure of which is incorporated therein by reference.

### BACKGROUND OF THE INVENTION

This invention relates to a path or route calculating apparatus for use in setting paths or routes in a network.

In the manner known in the art, a network comprises a plurality of nodes connected to one another through a plurality of transmission paths. A metric or a cost is defined to each of the transmission paths. In other words, each transmission path is assigned with the metric or the cost. One of the nodes serves as a source node while another of the nodes serves as a destination node. The source node may be called an origin node. There are a plurality of candidate paths or routes for coupling the source node with the destination node. It is assumed that an active path (or route) and a backup path (or route) are selected from among the plurality of candidate paths (or routes). The active path (or route) may be called a working path (or route). In this event, there is two basic criteria for selecting a pair of the active path (or route) and the backup path (or route) from among the plurality of candidate paths (or routes). The criteria are called path (or route) selection criteria or merely called selection criteria. In addition, it is premise that a path (route) exclusive to the active path (route) is selected as the backup path (route). That two paths (routes) are exclusive to each other means that those paths (routes) do not pass through the same nodes and the same transmission paths except for the source node and the destination node.

One of the path (route) selection criteria is a path (route) selection criterion for selecting, as the active path (route), one of the candidate paths (routes) that has a minimum metric. A metric of the path (route) is a sum of metrics of transmission paths through which the path (route) passes. When there is a plurality of candidate paths (routes) having the minimum metric, any one of them is selected as the active path (route). From among the candidate paths (routes) exclusive to the active path (route), a candidate path (route) having a minimum metric is selected as the backup path (route). Such a selection criteria is herein called a path (route) selection criterion 1. Inasmuch as the path (route) selection criterion 1 is not a criteria for selecting the active path (route) so as to guarantee that the backup path (route) exclusive to the active path (route) is ensured, there is a case where it is impossible to ensure the backup path (route) in spite of presence of a pair of exclusive candidate paths (routes).

Another of the path (route) selection criteria is disclosed in a book which is written by Ramesh Bhandri, which is published by Kluwer academic publishers, January 1999, pages 68-85, and which has a title of “SURVIVABLE NETWORKS: ALGORITHMS FOR DIVERSE ROUTING.” According to Ramesh Bhandri, a path (route) selection criterion comprises the steps of calculating two exclusive candidate paths (routes) having a minimum sum of metrics of the two exclusive candidate paths (routes), of selecting, as the active path (route), one of the two exclusive candidate paths (routes) having a smaller metric, and of selecting, as the backup path (route), another of the two exclusive candidate routes having a larger metric. This path (route) selection criterion is herein called a path (route) selection criterion 2. If the two exclusive candidate paths (routes) have equal metric, any one of the two exclusive candidate paths (routes) is selected as the active path (route) and the remaining one of the two exclusive candidate paths (routes) is selected as the backup path (route).

In a case of setting paths (routes) in an optical network in consideration of failure recovery, set routes are generally provided with protection types in the manner which is described in Internet Draft edited by Eric Mannie in Work in Progress, draft-ietf-ccamp-gmples-architetecture-01.txt, November 2001, under the title of “Generalized Multi-Protocol Label Switching (GMPLS) Architecture.” According to the Internet Draft, the protection types are classified into 1+1, 1:1, 1:N, and so on. In the protection type of 1+1, one backup resource is prepared for one active resource and traffic is flowed in both of the active resource and the backup resource before occurrence of failure. In the protection type of 1:1, one backup resource is prepared for one active resource and traffic is flowed in only the active resource before occurrence of failure. In the protection type 1:N, one backup resource is shared for N active resources and the protection type 1:N is similar to the protection type 1:1 except therefor, where N represents a positive integer which is not less two.

In prior art, in a case where paths (routes) having the protection type are set, a path (route) calculation using the same path (route) selection criterion is carried out without consideration of the protection type for the paths (routes). Therefore, a conventional path (route) calculating method is disadvantageous in that it is impossible to calculate paths (routes) in accordance with the protection type. In addition, the conventional path (route) calculating method is disadvantageous in that it is impossible to select the optimum paths (routes) from among the paths (routes) having the protection types such as 1:1, 1:N, or the like

Prior arts related to this invention are already known. A route selection method is disclosed in U.S. Pat. No. 5,321,815 issued to Leo J. Bartolanzo, Jr. et al. According to Bartolanzo, Jr. et al., a process for selecting a least weight path between two nodes in a data communication network uses partial trees created and cached in prior route selection operation. All root nodes on possible paths between the two nodes are identified. Any cached tree having a root matching one of the identified root nodes is retrieved from storage. If necessary, each retrieved tree is extended until it includes all possible destination nodes. The extended and/or retrieved trees are used to select the least weight path between the two nodes. The extended tree is then cached for possible use in future route selection operation.

A method of selecting least weight routes in a communications network is disclosed in U.S. Pat. No. 4,967,345 issued to Kathryn E. Clarke et al. According to Clarke et al., a least weight route computation algorithm for use in computing routes through a data communications network is improved by recording the number of equally weighted paths to a particular node through different predecessor nodes. If a route must be selected to the particular node, the relative numbers of equally weighted routes through different predecessor nodes determines the probability with which a route will be selected through the particular predecessor node.

Japanese Unexamined Patent Publication of Tokkai No. 2001-251344 or JP-A 2001-251344 provides a routing method and system that can reduce a delay time under a layered network and provides a storage medium storing a routing program. According to JP-A 2001-251344, when a node on a network is a source node, the source node calculates a least delay path up to a destination node, transmits calculated first path information to the destination node. The destination node acquires the first path information acquired from the source node, calculates a least delay path for a half path of the destination node while leaving the path as it is up to the number of hops being a half of the uppermost layer of the source node to acquire second path information, and uses a path summing the first path information and the second path information as a confirmed path.

Japanese Unexamined Patent Publication of Tokkai No. 2001-136199 or JP-A 2001-136199 provides a routing calculation system that can prevent a calculation amount for routing from being increased even when a metric provided to a network (NW) is frequently revised, provides a router that can prevent increase in a calculation load for the routing, and provides a routing system that maintains a transmission capacity to contents to be transferred by the network. According to JP-A 2001-136199, in the routing calculation system, a distance sequence graph liking all nodes in the order f distance from a border node, from a final tree taking each node of configuring the network. When the metric provided to the link of the network is revised, the routing is calculated so as to the network after the shorted node close the border node in both end nodes of the link.

### SUMMARY OF THE INVENTION

It is an object of this invention to provide a path calculating apparatus which is capable of calculating an active path and a backup path in a network in accordance with a protection type for the paths.

It is another object of this invention to provide a path selecting method which is capable of selecting an active path and a backup path in a network in accordance with a protection type for the paths.

It is still another object of this invention to provide a computer program which is capable of making a computer select an active path and a backup pash in a network in accordance with a protection tyne for the paths.

Other objects of this invention will become clear as the description proceeds.

According to a first aspect of this invention, a path calculating apparatus is for use in a network comprising a plurality of nodes connected to one another through a plurality of transmission paths each of which is assigned with a metric. One of the nodes serves as a source node while another of the nodes serves as a destination node. The path calculating apparatus calculates an active path and a backup path from among candidate pairs of candidate paths for the active path and of candidate paths for the backup path between the source node and the destination node. The candidate paths in each candidate pair are exclusive to each other. The path calculating apparatus comprises a criterion selecting arrangement for selecting, as a selected path selection criterion, one of a plurality of path selection criteria in accordance with a protection type and a path selecting arrangement for selecting the active path and the backup path from among the candidate pairs of candidate paths on the basis of the selected path selection criterion.

According to a second aspect of this invention, a method is for selecting an active path and a backup path in a network comprising a plurality of nodes connected to one another through a plurality of transmission paths each of which is assigned with a metric. One of the nodes serves as a source node while another of the nodes serves as a destination node. The method selects the active path and the backup path from among candidate pairs of candidate paths for the active path and of candidate paths for the backup path between the source node and the destination node. The candidate paths in each candidate pair are exclusive to each other. The method comprises the steps of selecting, as a selected path selection criterion, one of a plurality of path selection criteria in accordance with a protection type and of selecting the active path and the backup path from among the candidate pairs of candidate paths on the basis of the selected path selection criterion.

According to a third aspect of this invention, a computer program makes a computer select an active path and a backup path in a network comprising a plurality of nodes connected to one another through a plurality of transmission paths each of which is assigned with a metric. One of the nodes serves as a source node while another of the nodes serves as a destination node. The computer program makes the computer select the active path and the backup path from among candidate pairs of candidate paths for the active path and of candidate paths for the backup path between the source node and the destination node. The candidate paths in each candidate pair are exclusive to each other. The computer program causes the computer to perform the actions of selecting, as a selected path selection criterion, one of a plurality of path selection criteria in accordance with a protection type and of selecting the active path and the backup path from among the candidate pairs of candidate paths on the basis of the selected path selection criterion.

### BRIEF DESCRIPTION OF THE DRAWING

FIG. 1 is a block diagram showing a network;

FIG. 2 is a block diagram showing another network to which this invention is applicable;

FIG. 3 is a block diagram showing a path calculating apparatus according to an embodiment of this invention; and

FIG. 4 is a flow chart for use in describing operation of the path calculating apparatus illustrated in FIG. 3.

### DESCRIPTION OF THE PREFERRED EMBODIMENT

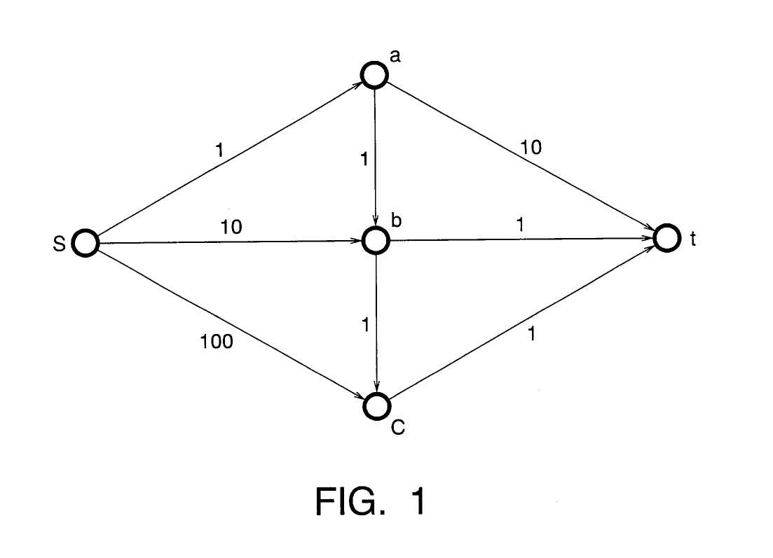

Referring to FIG. 1, the description will proceed to the above-mentioned path (route) selection criteria 1 and 2. In FIG. 1, it will be assumed that a network comprises a plurality of nodes s, t, a, b, and c which are connected to one another through a plurality of transmission paths each of which has a metric and a direction. The metric and the direction are denoted by a numeral and an arrow in FIG. 1, respectively. It will be assumed that the node s represents a source node, the node t is represents a destination node. A transmission path between the source node s and the node a has a metric of 1. A transmission path between the source node s and the node b has a metric of 10. A transmission path between the source node s and the node c has a metric of 100. A transmission path between the nodes a and b has a metric of 1. A transmission path between the nodes b and c has a metric of 1. A transmission path between the node a and the destination node t has a metric of 10. A transmission path between the node b and the destination node t has a metric of 1. A transmission path between the node c and the destination node t has a metric of 1.

Table 1 lists all of candidate paths (routes) which can reach from the source node s to the destination node t in the network illustrated in FIG. 1.

TABLE 1

| Path | Metric |
|---|---|
| s→a→t | 11 |
| s→a→b→t | 3 |
| s→a→b→c→t | 4 |
| s→b→t | 11 |
| s→b→c→t | 12 |
| s→c→t | 101 |

Inasmuch as the active path (route) is a path (route) having a minimum metric under the path (route) selection criterion 1, the candidate path (route) passing through the nodes s→a→b→t having the minimum metric is selected as the active path (route) as apparent from Table 1. Inasmuch as the backup path (route) is a path (route) having a minimum metric among the candidate paths (routes) exclusive the path (route) of s→a→b→t, the candidate path (route) passing through the nodes s→c→t is selected as the backup path (route).

Table 2 lists all of exclusive candidate pairs (path 1 and path 2 in Table 2) of candidate paths (routes) which can reach from the source node s to the destination node t in the network illustrated in FIG. 1 together with sums (Sum in Table 2) of metrics of two candidate paths (routes) and with smaller values (Min in Table 2) of the metrics of the candidate paths (routes).

TABLE 2

| path 1 | path 2 | Sum | Min |
|---|---|---|---|
| s→a→t | s→b→t | 22 | 11 |
| s→a→t | s→b→c→t | 23 | 11 |
| s→a→t | s→c→t | 112 | 11 |
| s→a→b→t | s→c→t | 104 | 3 |
| s→b→t | s→c→t | 112 | 11 |

A pair of candidate paths (routes) exclusive to each other that has a minimum sum of metrics of two candidate paths is calculated under the path (route) selection criterion 2. Inasmuch as a smaller one of them is the active path (route), the candidate path (route) passing through the nodes s→a→t is selected as the active path (route) and the path (route) passing through the nodes s→b→t is selected as the backup path (route).

In the manner which is described in the above-mentioned Internet Draft, set routes are generally provided with protection types. According to the Internet Draft, the protection types are classified into 1+1, 1:1, 1:N, and so on.

In prior art, in a case where paths (routes) having the protection type are set, a path (route) calculation using the same route selection criterion is carried out without consideration of the protection type for the paths (routes).

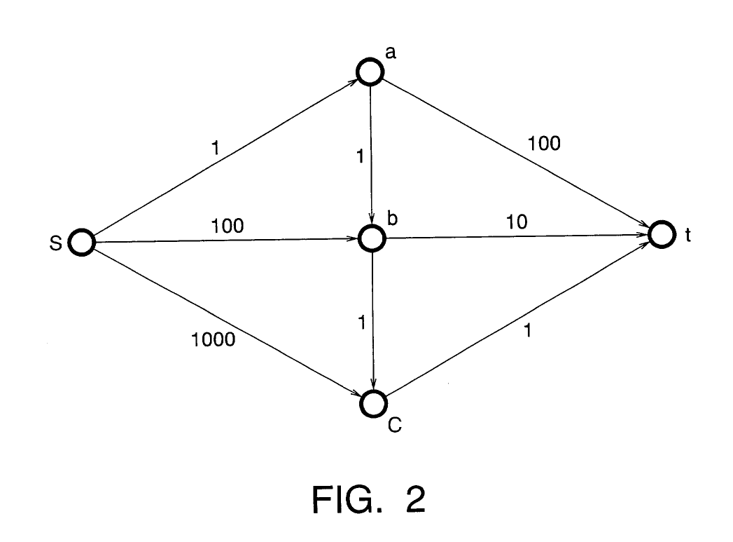

In a case where path (route) calculation is carried out under the path (route) selection criterion 1, the active path (route) and the backup path (route) may not be exclusive to each other dependent on the active path (route) calculated as the minimum metric path (route) passing where although there is two exclusive candidate paths. This matter will be described with reference to FIG. 2.

FIG. 2 shows a network comprises a plurality of nodes s, t, a, b, and c which are connected to one another through a plurality of transmission paths each of which has a metric and a direction. The metric and the direction are denoted by a numeral and an arrow in FIG. 2, respectively. It will be assumed that the node s represents a source node and the node t is represents a destination node. A transmission path between the source node s and the node a has a metric of 1. A transmission path between the source node s and the node b has a metric of 100. A transmission path between the source node s and the node c has a metric of 1000. A transmission path between the nodes a and b has a metric of 1. A transmission path between the nodes b and c has a metric of 1. A transmission path between the node a and the destination node t has a metric of 100. A transmission path between the node b and the destination node t has a metric of 10. A transmission path between the node c and the destination node t has a metric of 1.

Table 3 lists all of candidate paths which can reach from the source node s to the destination node t in the network illustrated in FIG. 2.

TABLE 3

| Path | Metric |
|---|---|
| s→a→t | 101 |
| s→a→b→t | 12 |
| s→a→b→c→t | 4 |
| s→b→t | 110 |
| s→b→c→t | 102 |
| s→c→t | 1001 |

Inasmuch as the active path (route) is the candidate path (route) having a minimum metric under the path (route) selection criterion 1, a path (route) passing through the nodes s→a→b→c→t is selected as the active path (route). If it is attempted to establish a backup path (route) for the active path (route), any possible backup path (route) from the source node s to the destination node t will inevitably share some part of the active path (route). In other words, an exclusive path (route) can not be selected as the backup path (route). As is apparent from FIG. 2, there is two exclusive candidate paths (routes).

When a path (route) calculation is made under the path (route) selection criterion 2, it never occurs that it is impossible to make the backup path (route) exclusive to the active path (route) that becomes an issue for calculation of the active path (route) under the path (route) selection criterion 1 as far as there is two exclusive candidate paths (routes). This matter will be also described with reference to FIG. 2.

Table 4 lists all of exclusive candidate pairs (path 1 and path 2 in Table 4) of candidate paths which can reach from the source node s to the destination node t in the network illustrated in FIG. 2 together with sums (Sum in Table 4) of metrics of two candidate paths and with smaller values (Min in Table 4) of the metrics of the candidate paths.

TABLE 4

| path 1 | path 2 | Sum | Min |
|---|---|---|---|
| s→a→t | s→b→t | 211 | 101 |
| s→a→t | s→b→c→t | 203 | 101 |
| s→a→t | s→c→t | 1102 | 102 |
| s→a→b→t | s→c→t | 1013 | 12 |
| s→b→t | s→c→t | 1111 | 110 |

In the network illustrated in FIG. 2, it is impossible to calculate the backup path (route) exclusive to the active path (route) when the active path (route) is calculated using the path (route) selection criterion 1. On the other hands, when the active path (route) is calculated using the path (route) selection criterion 2, a candidate pair of a candidate path (route) passing through the nodes s→a→t and a candidate path (route) passing through the nodes s→b→c→t is a pair of exclusive candidate paths (route) having a minimum sum of metrics. Therefore, the candidate path (route) passing through the nodes s→a→t is selected as the active path (route) while the candidate path (route) passing through the node s→b→c→t is selected as the backup path (route).

In the path (route) selection criterion 1, optimization of the active path (route) takes precedence and exclusiveness of the backup path (route) for the active path (route) is the next precedence. In the path (route) selection criterion 2, exclusiveness between the active path (route) and the backup path (route) and optimization of a sum of metrics of two paths (routes) are guaranteed. However, optimization of individual path (route) is not guaranteed. That is, it is possible to select, as the active path (route), a candidate path (route) having a metric smaller than that of the active path (route) calculated using the path (route) selection criterion 2 and it is possible to select a different path (route) selection criterion so as to ensure a path (route) exclusive to the active path (route).

However, a conventional path (route) calculating method is disadvantageous in that it is impossible to carry out a path (route) calculation in accordance with a protection type. This is because the conventional path (route) calculating method is a path (route) calculating method for using the same path selection criterion without consideration of a protection type which paths have. In addition, the conventional path (route) calculating method using the path (route) selection criteria is disadvantageous in that it is impossible to select optimum paths (routes) for paths (routes) having the protection types such as 1:1, 1:N, or the like.

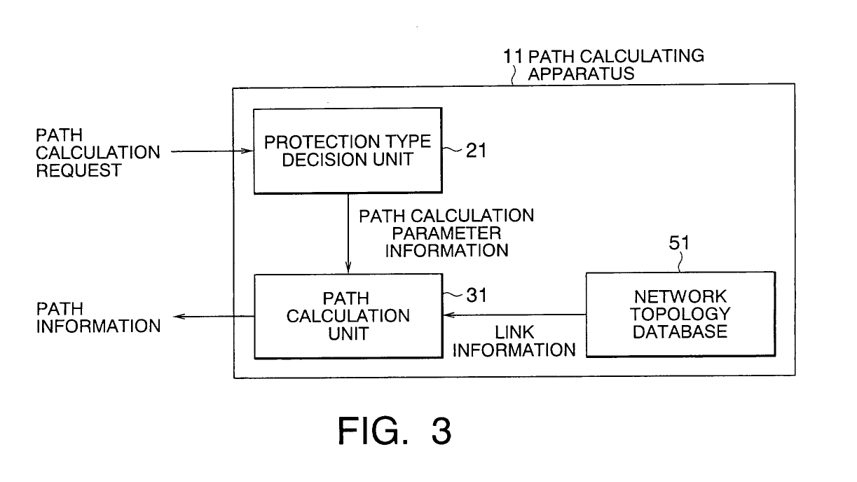

Referring to FIG. 3, the description will proceed to a path (route) calculating apparatus 11 according to an embodiment of this invention. The illustrated path calculating apparatus 11 comprises a protection type decision unit 21, a path calculation unit 31, and a network topology data base 51.

The path (route) calculating apparatus 11 is supplied with a path calculation request indicative to a source node, a destination node, a protection type, and other constraints. The network topology data base 51 stores link information indicative of a link for connecting two nodes in a network.

Supplied with the path (route) calculation request from a request source (not shown), the protection type decision unit 21 selects, as a selected path selection criterion, one of a plurality of path selection criteria in accordance with the protection type. That is, the protection decision unit 21 serves as a criterion selecting arrangement for selecting, as the selected path selection criterion, one of the path selection criteria in accordance with the protection type. In other words, the protection decision unit 21 identifies the protection type of paths (routes) as an identified protection type and selects, as the selected path (route) selection criterion, one of the path (route) selection criteria in accordance with the identified protection type.

In the manner which is described above, responsive to the path (route) calculation request from the request source, the path (route) selection criterion in accordance with the protection type designated by the path (route) calculation request is used. The protection decision unit 21 supplies the path calculation unit 31 with path calculation parameter information indicative of the selected path selection criterion. Responsive to the path calculation parameter information, the path calculation unit 31 executes an algorithm for searching a path which is satisfied with the path (route) selection criterion in accordance with the link information stored in the network topology data base 51. In other words, the path calculation unit 31 selects an active path and a backup path from among candidate pairs of candidate paths on the basis of the selected path selection criterion. That is, the path calculation unit 31 serves as a path selecting arrangement for selecting the active path and the backup path from the candidate pairs of the candidate paths on the basis of the selected path selection criterion. The path calculation unit 32 returns a calculated result indicative of path information to the request source as a path (route) calculation reply.

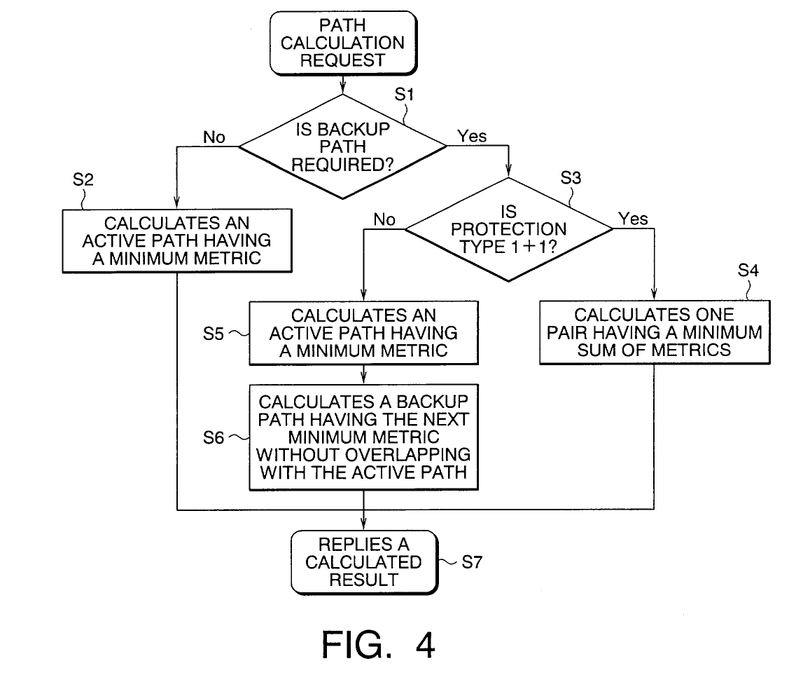

Referring to FIG. 4, description will be made as regards operation of the path calculating apparatus 11 illustrated in FIG. 3.

Responsive to the path calculation request, the protection type decision unit 21 determines whether or not the backup path is required at a step S1. When the backup path is not required, the step S1 proceeds to a step S2 at which the path calculation unit 31 calculates the active path having a minimum metric from among candidate paths. When the backup path is required, the step S1 is followed by a step S3 at which the protection type decision unit 21 determines whether or not the protection type is 1+1.

When the protection type is 1+1, the protection type decision unit 21 selects the selected path selection criterion for selecting, from among the candidate pairs, one pair having a minimum sum of metrics of the candidate paths as the active path and the backup path. That is, the step S3 is succeeded by a step S4 at which the path calculation unit 31 selects the active path and the backup path from among the candidate pairs of the candidate paths on the basis of the selected path selection criterion in question. In other words, the path calculation unit 31 calculates, from among the candidate pairs, one pair having the minimum sum of metrics of the candidate paths as the active path and the backup path at the step S4.

When the protection type is not 1+1 but is 1:1 or 1:N, the protection type decision unit 21 selects the selected path selection criterion for selecting, from among the candidate pairs, one pair including the candidate path for the active path having a minimum metric as the active path and the backup path. That is, the step S3 proceeds to steps S5 and S6 at which the path calculation unit 31 selects the active path and the backup path from among the candidate pairs of the candidate paths on the basis of the selected path selection criterion in question. In other words, the path calculation unit 31 calculates the active path having the minimum metric from among the candidate paths at the step S5. Subsequently, the path calculation unit 31 calculates the backup path having the next minimum metric from the candidate paths without overlapping with the active path at the step S6.

Finally, the path calculation unit 31 returns the path (route) calculation reply to the request source at a step S7.

Referring to FIG. 2 and Table 4, the description will proceed to a case of setting paths having the protection type of 1+1 and a case of setting paths having the protection type of 1:1 or 1:N using the path (route) calculating apparatus 11 according to the embodiment of this invention.

It will be assumed that the path (route) calculating apparatus 11 sets the paths having the protection type of 1+1 in the network illustrated in FIG. 2. Inasmuch as traffic always flows in both of the active path (route) and the backup path (route), a path (route) calculating method in consideration of optimization of both of the active path (route) and the backup path (route) is suitable rather than a path (route) calculation method in consideration of optimization of only the active path (route). Accordingly, in this path (route) calculating method, the path (route) selection criterion 2 is used as the selected path (route) selection criterion. As a result, inasmuch as two exclusive candidate paths having the minimum sum of the metrics of the two paths (routes) are calculated, the path (route) passing through the nodes s→a→t is selected as the active path (route) while the path (route) passing through the nodes s→b→c→t is selected as the backup path (route) with reference to Table 4.

It will be assumed that the path (route) calculating apparatus 11 sets the paths (routes) having the protection type of 1:1 or 1:N in the network illustrated in FIG. 2. Inasmuch as traffic flows in only the active path (route) except for on failure, a path (route) calculation method in consideration of optimization of the active path (route) is suitable. Accordingly, on the assumption that candidate pairs of candidate paths can ensure the backup path (route) exclusive to the active path (route), a candidate pair of candidate paths having a minimum metric from among the candidate pairs is calculated. As a result, the candidate path (route) passing through the nodes s→a→b→t is selected as the active path (route) while the path (route) passing through the nodes s→c→t is selected as the backup path (route) in accordance with Table 4.

In the manner which is described above, by changing the path (route) selection criteria to be used each protection type of the paths (routes), it is possible to calculate the paths (routes) suitable to the protection type of the paths (routes) in comparison with the conventional path (route) calculating method using the same path (route) selection criterion without consideration of the protection type.

Inasmuch as a candidate pair of two exclusive candidate paths (routes) having a sum of metrics of the two exclusive candidate paths (routes) are calculated when the protection type is 1+1, it is possible to carry out a path (route) calculation so as to guarantee optimization of a sum of metrics of the active path (route) and the backup path (route). When the protection type is 1:1 or 1:N, on the assumption that candidate pairs of candidate paths (routes) can ensure the backup path (route) exclusive to the active path (route), a pair of candidate paths (routes) for the active path (route) having a minimum metric from among the candidate pairs is calculated. It is therefore possible to carry out a path (route) calculation so as to guarantee optimization of the active path (route).

While this invention has thus far been described in conjunction with a preferred embodiment thereof, it will readily be possible for those skilled in the art to put this invention into practice in various other manners. For example, the path calculating apparatus may be realize by a computer comprising the steps of storing, in the computer, a program for making the computer carry out path calculation in the above-mentioned procedures and of carrying out, by the computer, the path calculation in accordance with the program. Although each communication path is assigned with the metric in the above-mentioned embodiment, each communication path may be assigned with a cost or the like in lieu of the metric.

What is claimed is:

1. A path calculating apparatus for use in a network comprising a plurality of nodes connected to one another through a plurality of transmission paths each of which is assigned with a metric, one of said nodes serving as a source node, another of said nodes serving as a destination node, said path calculating apparatus calculating an active path and a backup path from among candidate pairs of candidate paths for the active path and of candidate paths for the backup path between said source node and said destination node, the candidate paths in each candidate pair being exclusive to each other, said path calculating apparatus comprising:
a criterion selecting means for selecting, as a selected path selection criterion, one of a plurality of path selection criteria in accordance with a protection type; and
a path selecting means for selecting said active path and said backup path from among said candidate pairs of candidate paths on the basis of said selected path selection criterion.

2. A path calculating apparatus as claimed in claim 1, when said protection type is 1:1 or 1:N, said criterion selecting means selecting the selected path selection criterion for selecting, from among said candidate pairs, one pair including the candidate path for said active path having a minimum metric as said active path and said backup path.

3. A path calculating apparatus as claimed in claim 1, when said protection type is 1+1, said criterion selecting means selecting the selected path selection criterion for selecting, from among said candidate pairs, one pair having a minimum sum of metrics of said candidate paths as said active path and said backup path.

4. A method of selecting an active path and a backup path in a network comprising a plurality of nodes connected to one another through a plurality of transmission paths each of which is assigned with a metric, one of said nodes serving as a source node, another of said nodes serving as a destination node, said method selecting said active path and said backup path from among candidate pairs of candidate paths for the active path and of candidate paths for the backup path between said source node and said destination node, the candidate paths in each candidate pair being exclusive to each other, said method comprising the steps of:
(a) selecting, as a selected path selection criterion, one of a plurality of path selection criteria in accordance with a protection type; and
(b) selecting said active path and said backup path from among said candidate pairs of candidate paths on the basis of said selected path selection criterion.

5. A method as claimed in claim 4, when said protection type is 1:1 or 1:N, the step of selecting a selected path selection criterion selecting the selected path selection criterion for selecting, from among said candidate pairs, one pair including the candidate path for said active path having a minimum metric as said active path and said backup path.

6. A method as claimed in claim 4, when said protection type is 1+1, the step of selecting a selected path selection criterion selecting the selected path selection criterion for selecting, from among said candidate pairs, one pair having a minimum sum of metrics of said candidate paths as said active path and said backup path.

7. A computer program making a computer select an active path and a backup path in a network comprising a plurality of nodes connected to one another through a plurality of transmission paths each of which is assigned with a metric, one of said nodes serving as a source node, another of said nodes serving as a destination node, said computer program making said computer select said active path and said backup path from among candidate pairs of candidate paths for the active path and of candidate paths for the backup path between said source node and said destination node, the candidate paths in each candidate pair being exclusive to each other, said computer program causing said computer to perform the actions of:
(a) selecting, as a selected path selection criterion, one of a plurality of path selection criteria in accordance with a protection type; and
(b) selecting said active path and said backup path from among said candidate pairs of candidate paths on the basis of said selected path selection criterion.

8. A computer program as claimed in claim 7, when said protection type is 1:1 or 1:N, the action of selecting a selected path selection criterion selecting the selected path selection criterion for selecting, from among said candidate pairs, one pair including the candidate path for said active path having a minimum metric as said active path and said backup path.

9. A computer program as claimed in claim 7, when said protection type is 1+1, the action of selecting a selected path selection criterion selecting the selected path selection criterion for selecting, from among said candidate pairs, one pair having a minimum sum of metrics of said candidate paths as said active path and said backup path.
